(19) United States
(12) Patent Application Publication
(10) Pub. No.: US 2023/0282945 A1
(43) Pub. Date: Sep. 7, 2023

(54) BATTERY WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuya IKEDA, Mie (JP); Osamu NAKAYAMA, Mie (JP); Naoki FUKUSHIMA, Mie (JP); Katsushi MIYAZAKI, Mie (JP); Mitsutoshi MORITA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/011,260

(22) PCT Filed: Jun. 22, 2021
(86) PCT No.: PCT/JP2021/023600

§ 371 Date: Dec. 19, 2022

(30) Foreign Application Priority Data
Jul. 8, 2020 (JP) 2020-117491

(51) Int. Cl. H01M 50/503; H01M 50/507; H01M 50/519

(52) U.S. Cl. CPC H01M 50/503; H01M 50/507; H01M 50/519

(57) ABSTRACT

A battery wiring module is attached to a battery cell stack including a plurality of battery cells stacked and including electrode leads, to electrically connect the plurality of battery cells with each other. The battery wiring module includes: busbars having a plate shape; a flexible printed circuit board including board-side connection portions; and a protector holding the busbars and the flexible printed circuit board. The busbars include main bodies connected to the electrode leads, and busbar-side connection portions connected to the board-side connection portions. In the protector, the main bodies of the busbars, and the flexible printed circuit board are arranged perpendicularly to each other.

### TECHNICAL FIELD

The present disclosure relates to a battery wiring module.

### BACKGROUND ART

In a high-voltage battery pack used in an electric car, a hybrid car, and the like, many battery cells are usually stacked, and electrically connected with each other in series or in parallel by a battery wiring module. As such a battery wiring module, a battery module described in Japanese Translation of PCT International Application Publication No. JP-T-2019-500736 (Patent Literature 1 below) is conventionally known. The battery module described in Patent Literature 1 includes a battery cell stack and a busbar assembly. The battery cell stack includes a plurality of battery cells that are stacked on each other and have at least one side from which electrode leads protrude. The busbar assembly electrically couples, with a busbar, the electrode leads of the plurality of battery cells and includes at least one lead slot through which both the electrode leads of two adjacent ones of the battery cells pass. The electrode leads protrude in a direction orthogonal to the side surface of the battery cell stack, while the busbar is arranged parallel to the side surface of the battery cell stack.

### CITATIONS LIST

### Patent Literature

Patent Literature 1: Japanese Translation of PCT International Application Publication No. JP-T-2019-500736

### SUMMARY OF INVENTION

### Technical Problems

However, for the above configuration, in order to connect the busbar and the electrode leads, it is necessary to bend each of two adjacent ones of the electrode leads toward the busbar, so that the two adjacent ones lie on top of each other, which may complicate the structure of the battery module. In addition, since the busbar is arranged parallel to the side surface of the battery cell stack, a space where a shape for positioning the busbar is installed cannot be sufficiently secured. If the shape for positioning the busbar were installed, it would be difficult to reduce a space for the busbar assembly, for example, a space for other wiring portions would need to be reduced.

The present disclosure has been completed on the basis of the above circumstances, and an object of the present disclosure is to provide a battery wiring module configured to simplify the configuration and reduce a space for the battery wiring module.

### Solutions to Problems

A battery wiring module according to the present disclosure is attached to a battery cell stack including a plurality of battery cells stacked and including electrode leads, to electrically connect the plurality of battery cells with each other. The battery wiring module includes: busbars having a plate shape; a circuit board including board-side connection portions; and a protector holding the busbars and the circuit board. The busbars include main bodies connected to the electrode leads, and busbar-side connection portions connected to the board-side connection portions. In the protector, the main bodies of the busbars, and the circuit board are arranged perpendicularly to each other.

### Effects of Invention

According to the present disclosure, it is possible to provide a battery wiring module configured to simplify the configuration and reduce a space for the battery wiring module.

### BRIEF DESCRIPTION OF DRAWINGS

FIG. 1 is a perspective view illustrating a battery wiring module and a battery cell stack according to a first embodiment.

FIG. 2 is a front view of a front battery wiring module.

FIG. 3 is a perspective view of the front battery wiring module.

FIG. 4 is a perspective view of a battery cell.

FIG. 5 is a view illustrating joining of the front battery wiring module and the battery cell stack taken along cross section A-A of FIG. 2.

FIG. 6 is a cross-sectional view taken along line B-B of FIG. 2.

FIG. 7 is an enlarged perspective view illustrating soldering between a busbar-side connection portion of the battery wiring module and a board-side connection portion provided to the right of a hole edge portion of a connection hole.

FIG. 8 is an enlarged perspective view illustrating soldering between a busbar-side connection portion of the battery wiring module and a board-side connection portion provided around a whole hole edge portion of a connection hole.

FIG. 9 is an enlarged perspective view illustrating the surroundings around a connection hole of a flexible printed circuit board fixed to a protector.

FIG. 10 is an enlarged perspective view illustrating a positioning hole of the protector.

FIG. 11 is a perspective view of an intermediate busbar.

FIG. 12 is a perspective view of a negative-electrode busbar.

FIG. 13 is a perspective view of a positive-electrode busbar.

FIG. 14 is a perspective view of the protector. FIG. 15 is a cross-sectional view taken along line C-C of FIG. 2.

FIG. 16 is a cross-sectional view taken along line D-D of FIG. 2.

FIG. 17 is an enlarged perspective view illustrating soldering between a busbar-side connection portion and a board-side connection portion of a battery wiring module according to a second embodiment.

FIG. 18 is a perspective view of a front battery wiring module according to a third embodiment.

FIG. 19 is a perspective view of a flexible printed circuit board.

FIG. 20 is a perspective view illustrating attaching of the flexible printed circuit board to a busbar held by a protector.

FIG. 21 is an enlarged perspective view illustrating the surroundings around a connection hole provided such that the connection hole is continuous with an entry slit whose width is narrower than the width of a busbar.

### DESCRIPTION OF EMBODIMENTS

### Description of Embodiments of Present Disclosure

First, aspects of the present disclosure will be listed and described.

(1) A battery wiring module according to the present disclosure is attached to a battery cell stack including a plurality of battery cells stacked and including electrode leads, to electrically connect the plurality of battery cells with each other. The battery wiring module includes: busbars having a plate shape; a circuit board including board-side connection portions; and a protector holding the busbars and the circuit board. The busbars include main bodies connected to the electrode leads, and busbar-side connection portions connected to the board-side connection portions. In the protector, the main bodies of the busbars, and the circuit board are arranged perpendicularly to each other. Herein, “perpendicular” includes a case where it is perpendicular, and also includes a case where even if it is not perpendicular, it can be recognized that it is substantially perpendicular in which the angle formed by the busbars and the circuit board is about 85° to 95°. In addition, the state where the main bodies of the busbars and the circuit board are arranged perpendicularly to each other specifically indicates a state where thickness directions of the main bodies and a thickness direction of the circuit board are perpendicular to each other.

According to such a configuration, in the protector, the main bodies of the busbars and the circuit board are arranged perpendicularly to each other. Therefore, it is possible to directly join the main bodies of the busbars to the electrode leads without bending each of two adjacent ones of the electrode leads toward the main body of the busbar, so that the two adjacent ones lie on top of each other. Thus, the configuration of the battery wiring module can be simplified. In addition, since a space in the protector where the busbars are installed is reduced, a space where shapes for positioning the busbars are installed is easily secured, and the space of the battery wiring module can be reduced.

(2) Preferably, among the busbars, the busbar disposed between the electrode leads adjacent to each other is made of a clad material in which two or more different kinds of metals are integrated.

According to such a configuration, since the busbar includes joined metals having high connection strength for the electrode leads, it is possible improve the joining strength between the busbar and each of the adjacent electrode leads.

(3) Preferably, the busbar-side connection portions are surface-mounted on the board-side connection portions.

According to such a configuration, the busbar-side connection portions and the board-side connection portions can be connected by reflow without forming holes through the circuit board. Thus, for example, in a case where the busbar-side connection portions and the board-side connection portions are connected with each other with solder, the solder does not flow down through holes.

(4) Preferably, the circuit board includes connection holes through which the busbar-side connection portions are inserted, and the connection holes have hole edge portions where the board-side connection portions are provided. The hole edge portions of the connection holes are at least partly around the connection holes.

According to such a configuration, the busbar-side connection portions and the board-side connection portions can be connected in a state where the busbar-side connection portions are inserted in the connection holes.

(5) Preferably, the hole edge portions of the connection holes are formed in a recess shape, such that the hole edge portions are continuous with an outer edge portion of the circuit board.

According to such a configuration, the busbar-side connection portions can be assembled with the connection holes after the busbars are held by the protector.

(6) Preferably, the protector includes positioning holes receiving distal ends of the busbar-side connection portions inserted in the connection holes. According to such a configuration, a space in the protector where the busbars are installed also serves as a positioning space, and the busbars can be positioned with respect to the protector without newly providing members for the busbars. Therefore, the space of the configuration of the battery wiring module can be reduced.

(7) Preferably, the board-side connection portions are connected to one side surface of the busbar-side connection portions by soldering.

According to such a configuration, the work efficiency with which the board-side connection portions are soldered to the busbar-side connection portions is improved.

(8) Preferably, the circuit board is a flexible printed circuit board.

According to such a configuration, since the flexible printed circuit board is light and flexible, it is easy to assemble the battery wiring module.

### Details of Embodiments of Present Disclosure

Hereinafter, embodiments of the present disclosure will be described. It is intended that the present disclosure is not limited to these examples, but is indicated by the claims, and includes all modifications within the meaning equivalent to the claims and the scope of the claims.

### First Embodiment

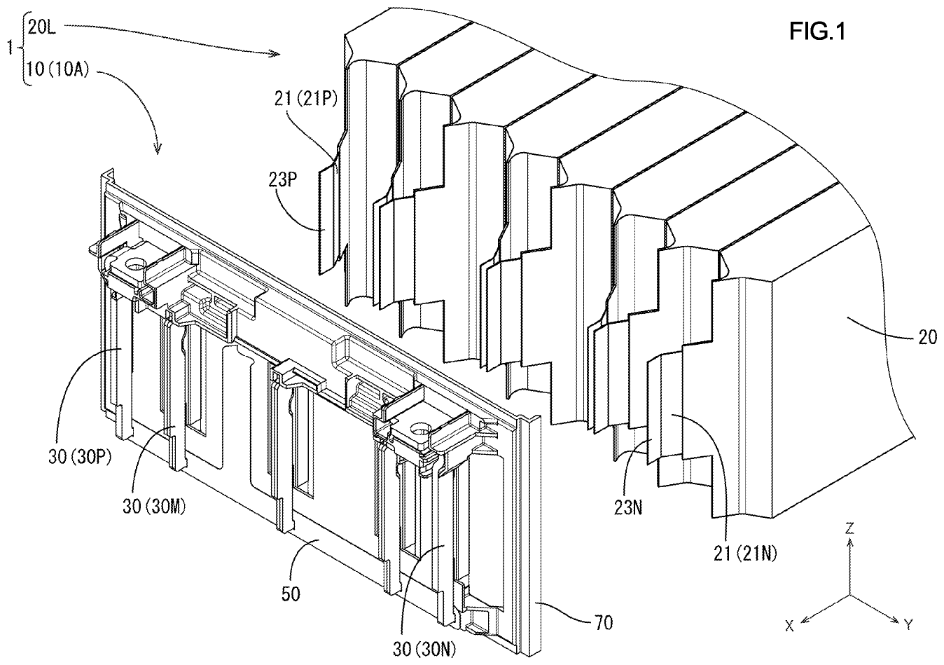

A first embodiment of the present disclosure will be described with reference to FIGS. 1 to 16. A battery module 1 including battery wiring modules 10 of the present embodiment is, for example, mounted on a vehicle, such as an electric car or a hybrid car, as a power source for driving the vehicle. In the following description, a direction indicated by an arrow line Z is an upward direction, a direction indicated by an arrow line X is a forward direction, and a direction indicated by an arrow line Y is a leftward direction. Note that for a plurality of the same members, only some of the members may be denoted by a reference sign, and the reference sign of the other members may be omitted.

### Battery Module and Battery Wiring Modules

As illustrated in FIG. 1, the battery module 1 of the first embodiment includes a battery cell stack 20L, and the battery wiring modules 10 attached to the battery cell stack 20L. The battery wiring module 10 includes busbars 30 having a plate shape, a flexible printed circuit board (hereinafter abbreviated as FPC) 50, and a protector 70 that holds the busbars 30 and the FPC 50. In the present embodiment, the FPC 50 is an example of a circuit board. Among the battery wiring modules 10, a member attached to the front side of the battery cell stack 20L is a front battery wiring module 10A, and a member attached to the rear side of the battery cell stack 20L is a rear battery wiring module (not illustrated).

### Battery Cells, Electrode Leads, Positive-Electrode Leads, and Negative-Electrode Leads

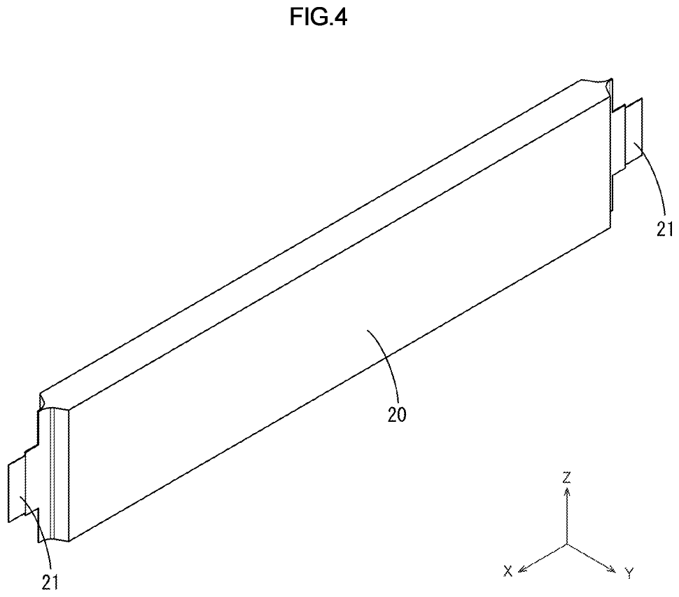

The battery cell stack 20L includes a plurality of battery cells 20 stacked. As illustrated in FIG. 4, the battery cell 20 has a flat shape. The battery cell 20 contains a power storage element (not illustrated). The battery cell 20 includes a pair of electrode leads 21. The pair of electrode leads 21 are arranged on both front-rear-direction sides of the battery cell 20, respectively. The pair of electrode leads 21 protrude such that the pair of electrode leads 21 face in respective opposite directions. The pair of electrode leads 21 have a plate shape, and have respective opposite polarities. That is, a negative-electrode lead 21N (an example of electrode leads) is provided at and protrudes from one lengthways-direction side of the battery cell 20, and a positive-electrode lead 21P (an example of the electrode leads) is provided at and protrudes from the other lengthways-direction side of the battery cell 20. Hereinafter, when the negative-electrode lead 21N and the positive-electrode lead 21P are not distinguished from each other, the negative-electrode lead 21N and the positive-electrode lead 21P are simply described as the electrode lead 21.

In the present embodiment, the battery cell 20 is, for example, a secondary battery, such as a lithium-ion battery. The negative-electrode lead 21N is made of copper, and the positive-electrode lead 21P is made of aluminum.

The battery cell stack 20L includes the electrode leads 21 protruding forward from the respective battery cells 20, and the electrode leads 21 protruding rearward from the respective battery cells 20. The electrode leads 21 protruding forward are electrically connected to each other by the front battery wiring module 10A. The electrode leads 21 protruding rearward are electrically connected to each other by the rear battery wiring module.

The electrode leads 21 protruding forward from the battery cell stack 20L are appropriately bent and cut to a necessary length to be connected to the front battery wiring module 10A. As illustrated in FIG. 1, among the electrode leads 21 protruding forward from the battery cell stack 20L, the electrode lead 21 positioned at the left end is the negative-electrode lead 21N, and is preliminarily bent rightward. The protruding end of the left-end negative-electrode lead 21N is a negative-electrode extension portion 23N extending in a protruding direction (forward), and is connected to a negative-electrode busbar 30N (an example of busbars) to be described later. Among the electrode leads 21 protruding forward from the battery cell stack 20L, the electrode lead 21 located at the right end is the positive-electrode lead 21P, and is preliminarily bent leftward. The protruding end of the right-end positive-electrode lead 21P is a positive-electrode extension portion 23P extending in the protruding direction (forward), and is connected to a positive-electrode busbar 30P (an example of the busbars) to be described later. Therefore, the negative-electrode lead 21N and the positive-electrode lead 21P do not need to be bent toward the negative-electrode busbar 30N and toward the positive-electrode busbar 30P when being connected to the negative-electrode busbar 30N and the positive-electrode busbar 30P.

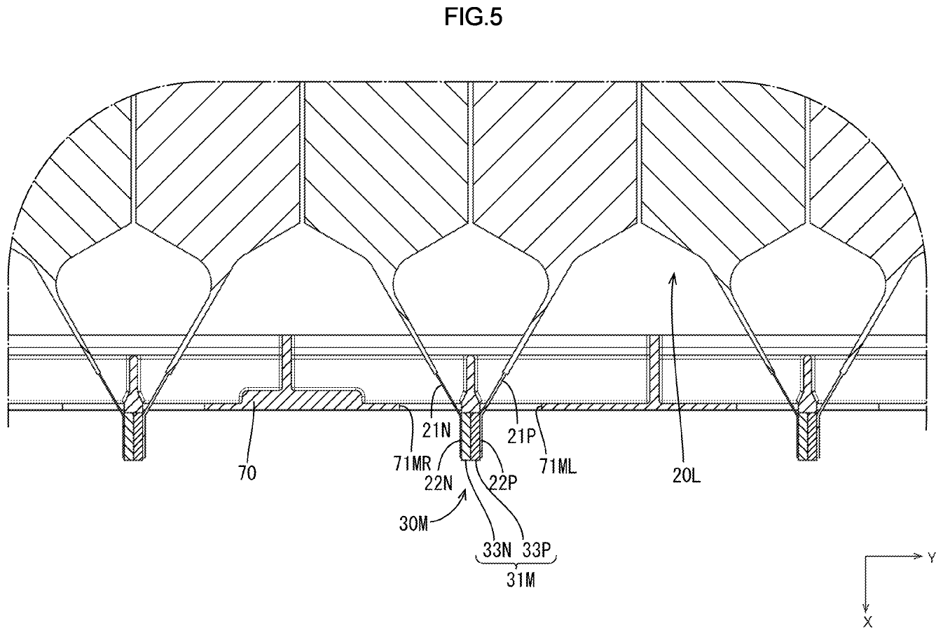

As illustrated in FIG. 5, among the electrode leads 21 protruding forward from the battery cell stack 20L, with respect to the electrode leads 21 positioned in an intermediate portion, the negative-electrode leads 21N are bent leftward, and the positive-electrode leads 21P are bent rightward. That is, the negative-electrode lead 21N and the positive-electrode lead 21P adjacent to each other are bent such that the negative-electrode lead 21N and the positive-electrode lead 21P approach each other. The protruding ends of the negative-electrode lead 21N and the positive-electrode lead 21P are intermediate extension portions 22N and 22P extending in parallel in the protruding direction (forward). The intermediate extension portions 22N and 22P are connected to an intermediate busbar 30M (an example of the busbars) to be described later. Therefore, the negative-electrode lead 21N and the positive-electrode lead 21P adjacent to each other do not need to be bent toward the intermediate busbar 30M when being connected to the intermediate busbar 30M. Although not illustrated, the configuration of the electrode leads 21 protruding rearward from the battery cell stack 20L is the same as the configuration of the electrode leads 21 positioned in the intermediate portion, among the electrode leads 21 protruding forward from the battery cell stack 20L.

### Busbars, Intermediate Busbars, Negative-Electrode Busbar, and Positive-Electrode Busbar

As illustrated in FIG. 1, the front battery wiring module 10A includes, as the busbars 30, the negative-electrode busbar 30N located at the left end, the positive-electrode busbar 30P located at the right end, and the intermediate busbars 30M located in the intermediate portion. Hereinafter, in a case where the intermediate busbars 30M, the negative-electrode busbar 30N, and the positive-electrode busbar 30P are not distinguished, they are simply described as the busbar 30. On the other hand, the rear battery wiring module (not illustrated) includes only the intermediate busbars 30M as the busbars 30. Since the rear battery wiring module has a configuration similar to the configuration of the front battery wiring module 10A, only the configuration of the front battery wiring module 10A will be described in detail below.

The busbar 30 is formed by processing a metal plate having conductivity. In the present embodiment, the intermediate busbar 30M is made of a clad material including copper and aluminum joined in a thickness direction. The negative-electrode busbar 30N is made of copper. The positive-electrode busbar 30P is made of aluminum.

### Main Body and Busbar-Side Connection Portion

The busbar 30 includes a main body 31 connected to the electrode lead 21, and a busbar-side connection portion 32 connected to the FPC 50 described later. This configuration is common to the intermediate busbars 30M, the negative-electrode busbar 30N, and the positive-electrode busbar 30P. Hereinafter, detailed configurations of the intermediate busbars 30M, the negative-electrode busbar 30N, and the positive-electrode busbar 30P will be described.

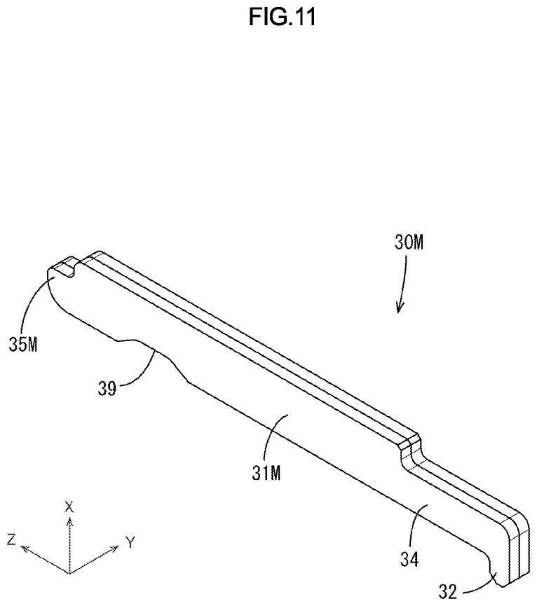

As illustrated in FIG. 11, a central portion of the intermediate busbar 30M is a main body 31M. The up-down-direction length of the main body 31M is formed larger than the up-down-direction lengths of the negative-electrode lead 21N and the positive-electrode lead 21P. As illustrated in FIG. 5, the thickness of the main body 31M is set equal to or smaller than the gap between the intermediate extension portions 22N and 22P adjacent to each other in the battery cell stack 20L. The main body 31M includes a negative-electrode joining portion 33N connected to the intermediate extension portion 22N, and a positive-electrode joining portion 33P connected to the intermediate extension portion 22P. A joining plane between the negative-electrode joining portion 33N and the intermediate extension portion 22N, and a joining plane between the positive-electrode joining portion 33P and the intermediate extension portion 22P are disposed such that the planes oppositely face in thickness directions. The negative-electrode joining portion 33N side is copper. The positive-electrode joining portion 33P side is aluminum. As illustrated in FIG. 11, a recess 39 that dips forward is provided in an upper rear surface of the main body 31M. A busbar-side connection portion 32 is provided at and protrudes rearward from a lower portion of the main body 31M via a coupling portion 34. The main body 31M protrudes forward with respect to an upper end portion 35M and the coupling portion 34 of the intermediate busbar 30M.

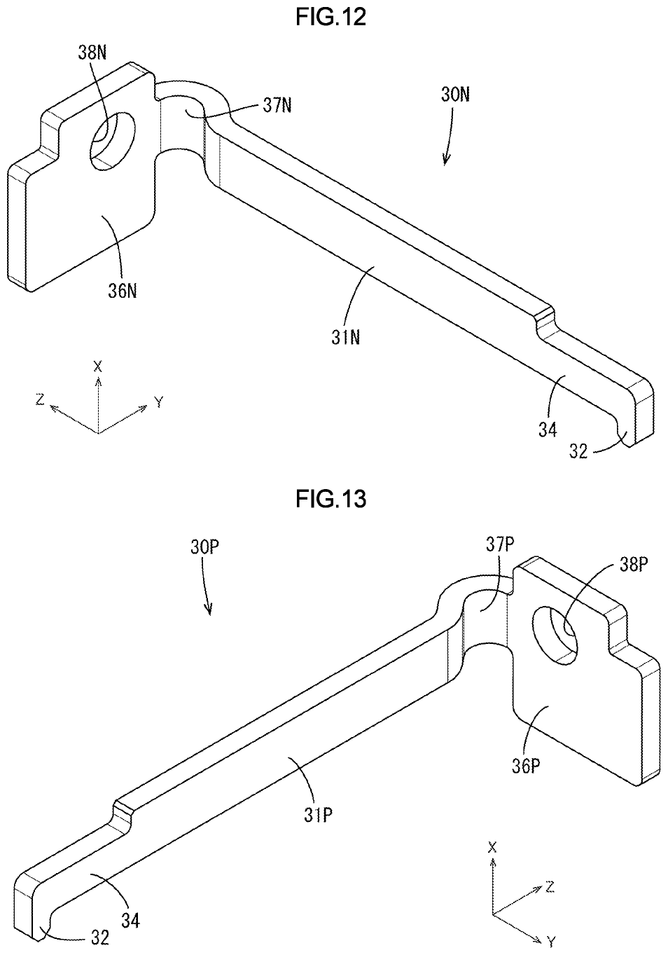

As illustrated in FIG. 12, the negative-electrode busbar 30N includes a main body 31N, a busbar-side connection portion 32, and a terminal portion 36N connected to an external device. A central portion of the negative-electrode busbar 30N is the main body 31N. The busbar-side connection portion 32 of the negative-electrode busbar 30N has a shape similar to the shape of the busbar-side connection portion 32 of the intermediate busbar 30M. The busbar-side connection portion 32 is formed such that the busbar-side connection portion 32 is continuous with the main body 31N via a coupling portion 34. The terminal portion 36N is provided at an upper end portion of the negative-electrode busbar 30N. The terminal portion 36N is formed such that the terminal portion 36N is continuous with an upper end portion of the main body 31N via a bent portion 37N. The negative-electrode busbar 30N is bent rightward at the bent portion 37N. A thickness direction of the main body 31N is a left-right direction, whereas a thickness direction of the terminal portion 36N is an up-down direction. A circular through hole 38N is formed through the terminal portion 36N in the up-down direction. The negative-electrode busbar 30N is connected to the negative-electrode extension portion 23N of the left-end negative-electrode lead 21N (see FIG. 1), and the terminal portion 36N functions as a negative electrode of the battery module 1.

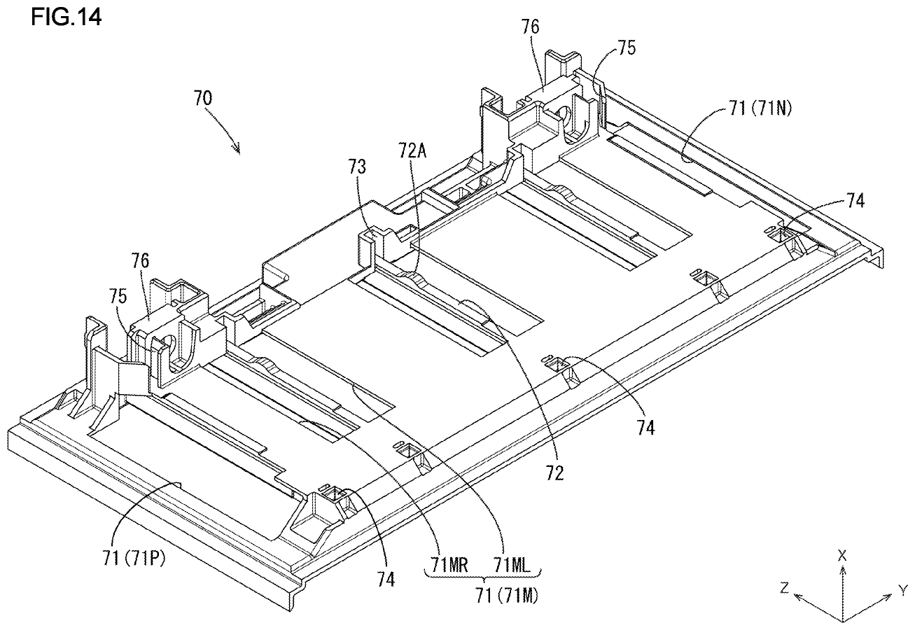

As illustrated in FIG. 13, the positive-electrode busbar 30P is configured similarly to the negative-electrode busbar 30N, and includes a main body 31P, a busbar-side connection portion 32, a coupling portion 34, a terminal portion 36P having a through hole 38P, and a bent portion 37P. The positive-electrode busbar 30P as a whole has a shape obtained by left-right flipping the negative-electrode busbar 30N. The positive-electrode busbar 30P is connected to the positive-electrode extension portion 23P of the right-end positive-electrode lead 21P (see FIG. 1), and the terminal portion 36P functions as a positive electrode of the battery module 1.

### Flexible Printed Circuit Board

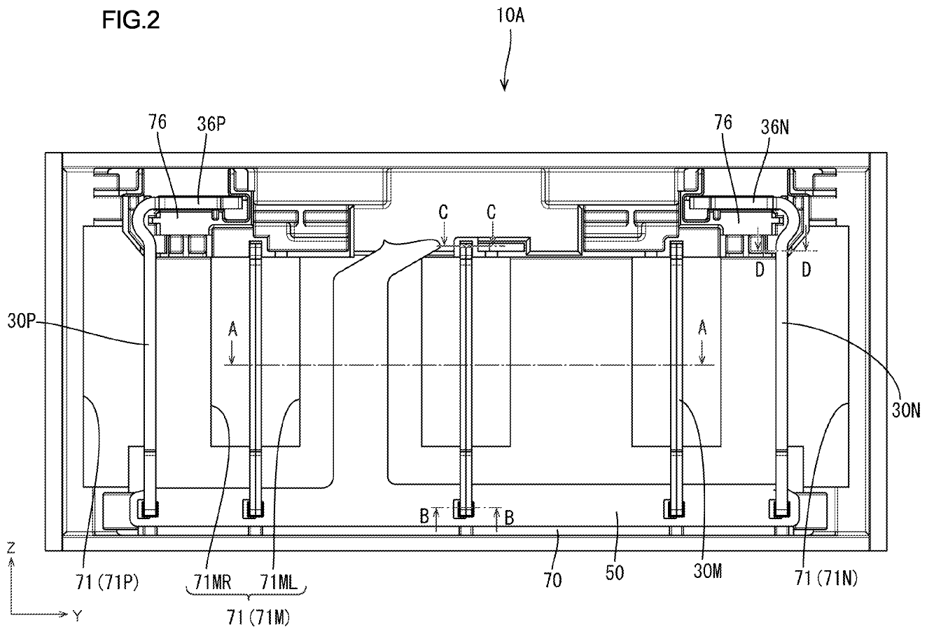

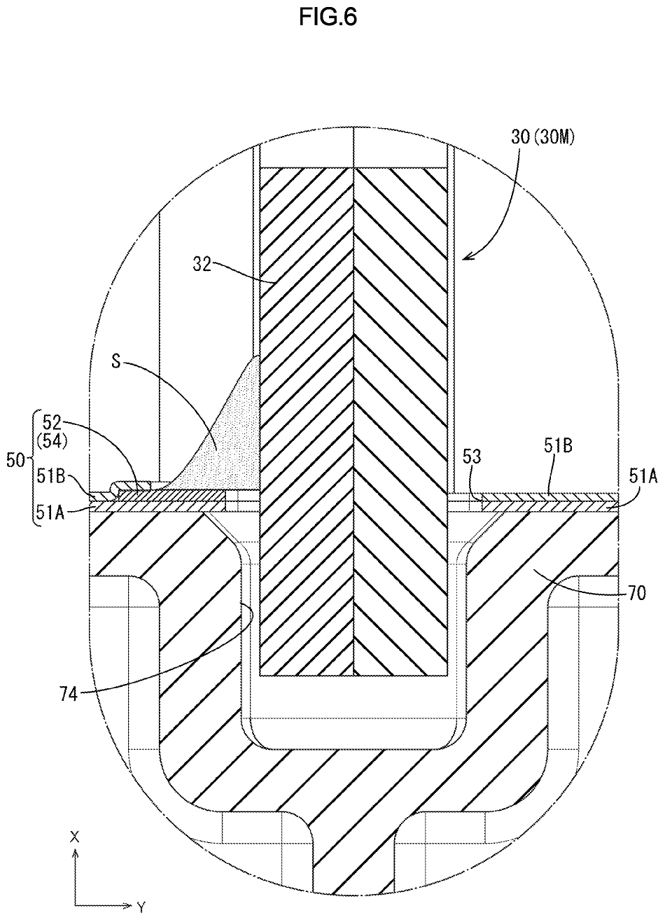

As illustrated in FIG. 6, the FPC 50 includes a base film 51A, a coverlay film 51B, and a plurality of conductive paths 52 (in FIG. 6, the thicknesses of the base film 51A and the like are illustrated larger than the actual thicknesses for the sake of the description). The base film 51A and the coverlay film 51B are made of an insulating flexible synthetic resin, such as polyimide. The conductive paths 52 are covered, from the rear, by the base film 51A, and is covered, from the front, by the coverlay film 51B. The conductive paths 52 are formed of a metallic foil, such as copper or a copper alloy. Optional electronic components, such as a resistor, a capacitor, and a transistor, may be connected to the conductive paths 52 although the illustration and description will be omitted below. As illustrated in FIGS. 2 and 6, the FPC 50 is fixed to the front surface of the protector 70 such that a thickness direction of the FPC 50 is a front-rear direction.

### Connection Holes and Board-Side Connection Portions

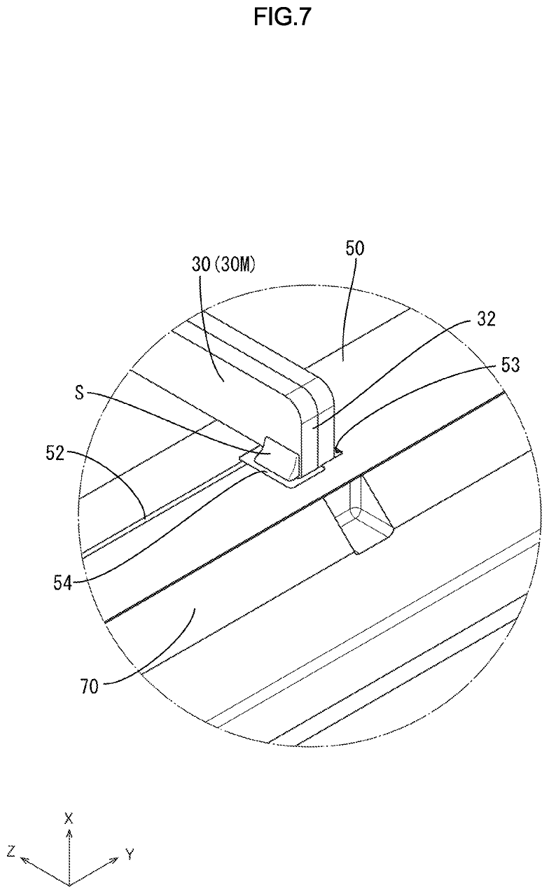

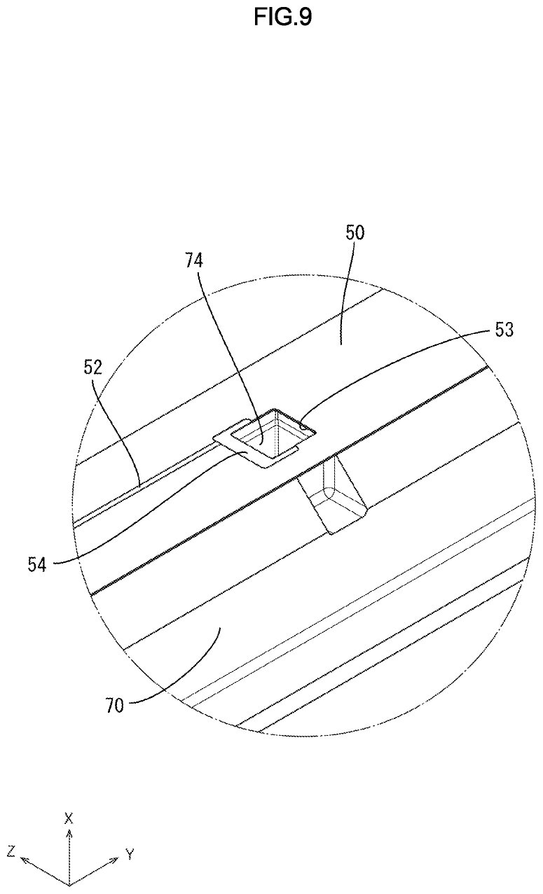

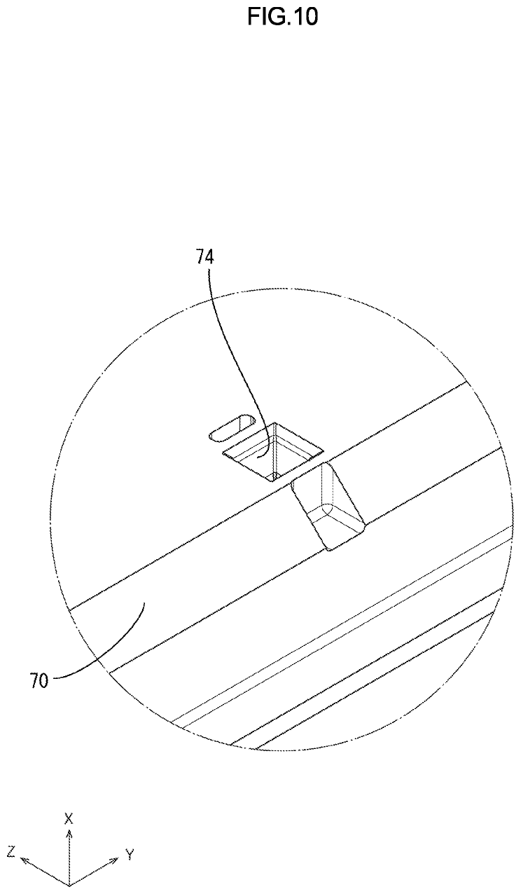

As illustrated in FIG. 9, connection holes 53 that have a rectangular shape are formed through the FPC 50 in a thickness direction. The up-down-direction and left-right-direction dimensions of the connection holes 53 are set larger than the up-down-direction and left-right-direction dimensions of the busbar-side connection portions 32. The connection hole 53 is disposed such that the connection hole 53 is continuous with a positioning hole 74 (see FIG. 10) of the protector 70 described later. A board-side connection portion 54 connected to an end portion of the conductive path 52 is provided at a hole edge portion of the connection hole 53. The board-side connection portion 54 is only required to be formed at least partly around the connection hole 53. In FIG. 9, the board-side connection portion 54 is provided to the right of the connection hole 53 such that the board-side connection portion 54 is in contact with three sides of a square constituting the hole edge of the connection hole 53. However, for example, the board-side connection portion 54 may be provided such that the board-side connection portion 54 is in contact with only the one right side of the square constituting the hole edge of the connection hole 53. The board-side connection portion 54 is made of a metallic foil similar to the metallic foil of the conductive paths 52. As illustrated in FIG. 6, the coverlay film 51B is preliminarily provided with openings, and the board-side connection portions 54 are exposed forward. As illustrated in FIGS. 6 and 7, the busbar-side connection portion 32 is inserted into the connection hole 53 from the front side, and the busbar-side connection portion 32 and the board-side connection portion 54 are electrically connected with solder S. Although aluminum has lower solder wetting than copper, it is known that aluminum is plated with tin or nickel to improve the solder wetting. Therefore, for the board-side connection portion 54, and the busbar-side connection portion 32 of the positive-electrode busbar 30P (and the positive-electrode joining portion 33P side of the intermediate busbar 30M) made of aluminum, the aluminum is plated with tin or nickel to allow the connection with the solder S. Although not illustrated, an end portion of each of the conductive paths 52 on a side opposite to the board-side connection portion 54 side is electrically connected to an external electronic control unit (ECU). The ECU includes a microcomputer, elements, and the like, and has a publicly known configuration having functions for detecting the voltages, currents, temperatures, and the like of the battery cells 20, and performing charge and discharge control of each battery cell 20, and the like.

The board-side connection portion 54 illustrated in FIGS. 6 and 7 is provided to the right of the hole edge portion of the connection hole 53, and is soldered to the right side surface of the busbar-side connection portion 32. As described above, a configuration in which the board-side connection portion 54 and one side surface of the busbar-side connection portion 32 are soldered is adopted, so that the soldering work can be efficiently performed using a general soldering iron.

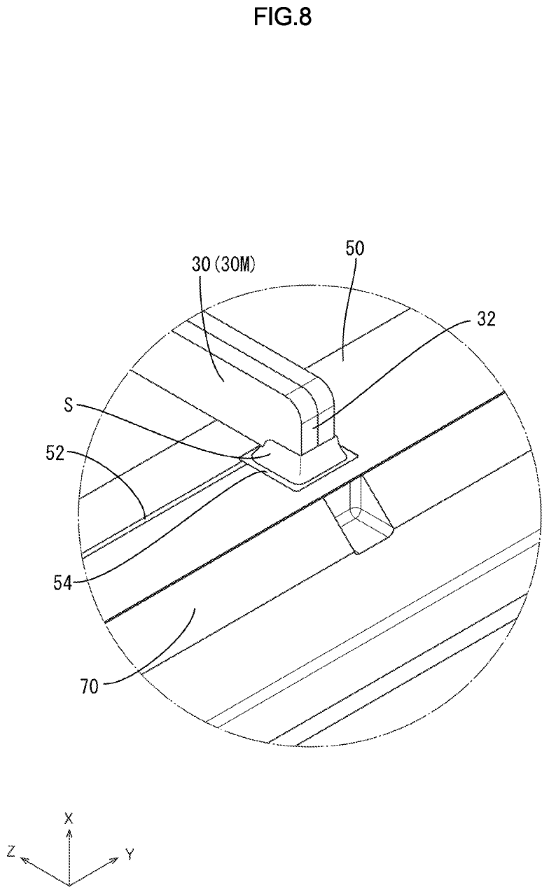

Alternatively, the board-side connection portion 54 may be provided on both the left and right sides of the hole edge portion of the connection hole 53, or may be provided at the peripheral edge portion of the hole edge portion of the connection hole 53, and may be soldered to a plurality of side surfaces of the busbar-side connection portion 32. For example, as illustrated in FIG. 8, the board-side connection portion 54 may be provided around the whole hole edge portion of the connection hole 53, and the busbar-side connection portion 32 and the board-side connection portion 54 may be connected to each other at the four sides of the upper, lower, left, and right sides by the solder S. In this case, the portion connected by the solder S is enlarged to provide an effect that the busbar 30 is stabilized with respect to the FPC 50. Since the number of soldered side surfaces of the busbar-side connection portion 32 increases, work efficiency may be a problem. However, the work efficiency can be improved by, for example, using a special soldering iron matching the shape of the busbar-side connection portion 32.

### Protector

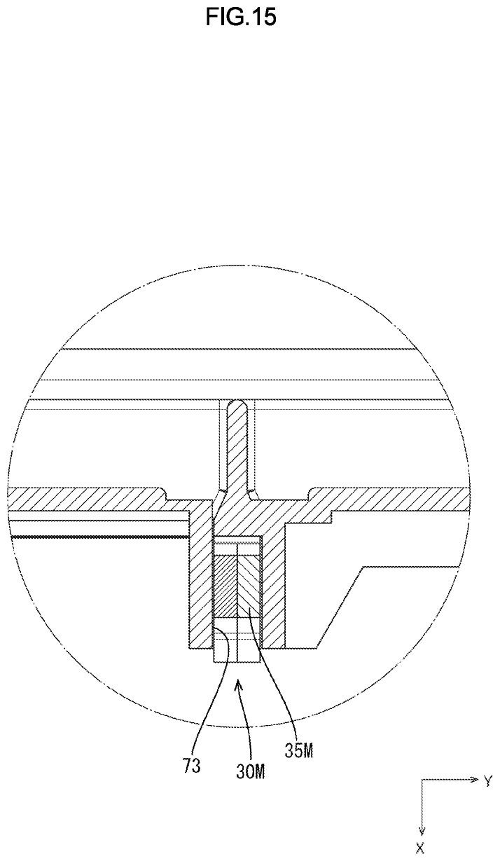

The protector 70 is made of an insulating synthetic resin, and has a plate shape as illustrated in FIG. 14. As illustrated in FIGS. 2 and 14, a plurality of electrode receiving portions 71 is provided at an up-down-direction central portion of the protector 70, and align in the left-right direction. The plurality of electrode receiving portions 71 is formed through in the front-rear direction, and has a rectangular shape that is up-down elongated. The plurality of electrode receiving portions 71 includes a negative-electrode receiving portion 71N located at the left end, a positive-electrode receiving portion 71P located at the right end, and intermediate electrode-receiving portions 71M located therebetween.

### Positioning Hole

As illustrated in FIGS. 2 and 14, the intermediate electrode-receiving portion 71M is divided into a left intermediate electrode-receiving portion 71ML and a right intermediate electrode-receiving portion 71MR. As illustrated in FIG. 5, the left intermediate electrode-receiving portion 71ML and the right intermediate electrode-receiving portion 71MR are provided such that the left intermediate electrode-receiving portion 71ML and the right intermediate electrode-receiving portion 71MR receive the positive-electrode lead 21P and the negative-electrode lead 21N that protrude toward the front of the battery cell stack 20L and are connected to the intermediate busbar 30M. As illustrated in FIG. 14, a contact portion 72 with which the intermediate busbar 30M is in contact from the front is provided between the left intermediate electrode-receiving portion 71ML and the right intermediate electrode-receiving portion 71MR. Provided on the upper side of the contact portion 72 is a projection 72A that gently protrudes forward. A wall portion that has a gate shape in front view is provided on and protrudes forward from the front surface of the protector 70, so that a groove 73 that opens downward and forward is provided above the contact portion 72. As illustrated in FIG. 15, the groove 73 is formed to receive and hold the upper end portion 35M of the intermediate busbar 30M. A thickness direction of the intermediate busbar 30M held in the groove 73 is disposed in the left-right direction. As illustrated in FIG. 14, the positioning hole 74 is provided below the contact portion 72. As illustrated in FIG. 10, the positioning hole 74 has a rectangular shape, and is formed such that the positioning hole 74 dips rearward from the front surface of the protector 70. The up-down-direction and left-right-direction dimensions of the positioning hole 74 are set larger than the up-down-direction and left-right-direction dimensions of the busbar-side connection portion 32. As illustrated in FIG. 6, the positioning hole 74 receives the distal end of the busbar-side connection portion 32 inserted in the connection hole 53 of the FPC 50, and positions the busbar 30 with respect to the protector 70.

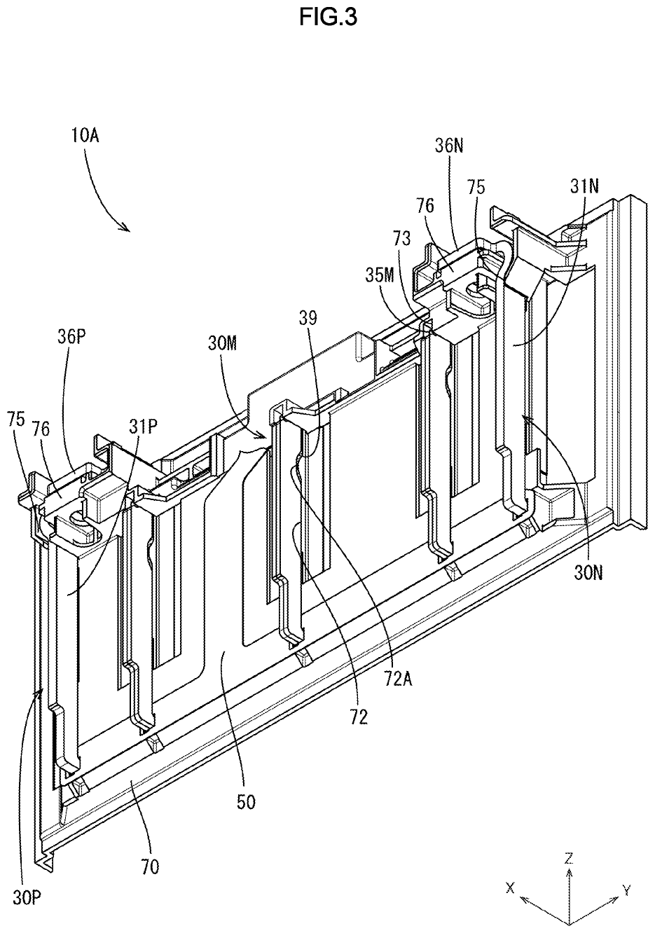

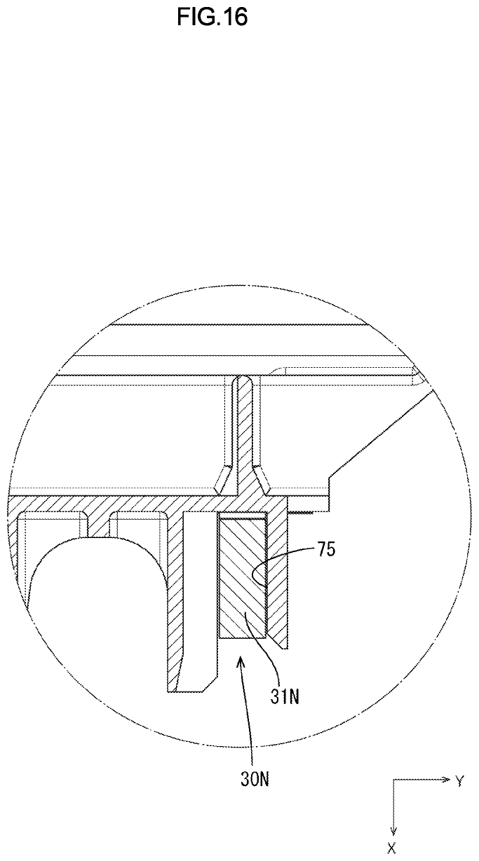

The negative-electrode receiving portion 71N is provided such that the negative-electrode receiving portion 71N receives the negative-electrode lead 21N that protrudes toward the front of the battery cell stack 20L and is connected to the negative-electrode busbar 30N. As illustrated in FIG. 14, a holder 75 protruding from the front surface of the protector 70 is provided at an upper hole edge portion to the right of the negative-electrode receiving portion 71N. As illustrated in FIG. 16, the holder 75 receives and holds an upper end portion of the main body 31N of the negative-electrode busbar 30N. A thickness direction of the main body 31N held by the holder 75 is the left-right direction. As illustrated in FIG. 14, a positioning hole 74 similar to that illustrated in FIG. 10 is formed in a lower hole edge portion to the right of the negative-electrode receiving portion 71N. A terminal block 76 protruding forward from the front surface of the protector 70 is provided above and to the right of the holder 75. The terminal block 76 has a horizontal upper surface. As illustrated in FIGS. 2 and 3, the terminal portion 36N of the negative-electrode busbar 30N is in contact with the terminal block 76 from above. The terminal block 76 includes a bolt-fixed portion (not illustrated). The bolt-fixed portion of the terminal block 76 allows a bolt to be inserted into and fixed to the through hole 38N of the terminal portion 36N placed on the terminal block 76, and a through hole of a terminal of an external device (not illustrated).

The positive-electrode receiving portion 71P is provided such that the positive-electrode receiving portion 71P receives the positive-electrode lead 21P that protrudes toward the front of the battery cell stack 20L and is connected to the positive-electrode busbar 30P. As illustrated in FIG. 14, a holder 75, a positioning hole 74, and a terminal block 76 as members for holding the positive-electrode busbar 30P are provided around the positive-electrode receiving portion 71P, like around the negative-electrode receiving portion 71N.

The present embodiment has the above-described configuration, and next, an example of an assembly procedure of the battery wiring module 10 will be described, and subsequently, an example of an assembly procedure of the battery module 1 will be described.

### Assembly of Battery Wiring Module

First, the FPC 50 is placed on the front surface of the protector 70. As illustrated in FIG. 9, the FPC 50 is arranged such that the positioning holes 74 of the protector 70 are continuous with the rear of the connection holes 53. The FPC 50 is attached to the front surface of the protector 70 by a publicly known technique, such as adhering or welding.

Next, each busbar 30 is attached to the protector 70. As illustrated in FIGS. 3 and 15, the upper end portion 35M of the intermediate busbar 30M is fitted into and held in the groove 73. As illustrated in FIG. 3, the rear surface of the intermediate busbar 30M comes into contact with the contact portion 72 from the front, and the recess 39 and the projection 72A engage with each other. As illustrated in FIGS. 6 and 7, the busbar-side connection portion 32 of the intermediate busbar 30M is inserted into the connection hole 53, and the distal end of the busbar-side connection portion 32 engages with the positioning hole 74.

As illustrated in FIGS. 3 and 16, an upper end portion of the main body 31N of the negative-electrode busbar 30N is fitted into the holder 75. The terminal portion 36N comes into contact with an upper surface of the terminal block 76. The busbar-side connection portion 32 is inserted into the connection hole 53, and the distal end of the busbar-side connection portion 32 engages with the positioning hole 74 (see FIGS. 6 and 7). Similarly to the negative-electrode busbar 30N, the positive-electrode busbar 30P is also attached to and held by the protector 70.

As illustrated in FIGS. 6 and 7, the busbar-side connection portions 32 of the respective busbars 30 are electrically connected to the board-side connection portions 54 of the FPC 50 by soldering. Thus, the battery wiring module 10 is completed.

### Assembly of Battery Module

The front battery wiring module 10A is attached to the front side of the battery cell stack 20L. As illustrated in FIG. 5, the left intermediate electrode-receiving portion 71ML and the right intermediate electrode-receiving portion 71MR receive the positive-electrode lead 21P and the negative-electrode lead 21N that are preliminarily bent to approach each other. The negative-electrode receiving portion 71N receives the negative-electrode lead 21N preliminarily bent rightward. The positive-electrode receiving portion 71P receives the positive-electrode lead 21P preliminarily bent leftward. The main body 31M of the intermediate busbar 30M is inserted between the intermediate extension portion 22N of the negative-electrode lead 21N and the intermediate extension portion 22P of the positive-electrode lead 21P that are adjacent to each other. The left side surface of the main body 31N of the negative-electrode busbar 30N is close to and faces the negative-electrode extension portion 23N of the negative-electrode lead 21N. The right side surface of the main body 31P of the positive-electrode busbar 30P is close to and faces the positive-electrode extension portion 23P of the positive-electrode lead 21P.

The busbars 30 and the respective electrode leads 21 that are close to each other, as described above, are irradiated with laser beam to perform laser welding. Thus, the negative-electrode joining portion 33N of the intermediate busbar 30M and the intermediate extension portion 22N are joined to each other, and the positive-electrode joining portion 33P of the intermediate busbar 30M and the intermediate extension portion 22P are joined to each other. A left side surface of the negative- electrode busbar 30N and the negative-electrode extension portion 23N are joined to each other, and a right side surface of the positive-electrode busbar 30P and the positive-electrode extension portion 23P are joined to each other. The rear battery wiring module is also attached to the rear side of the battery cell stack 20L in the same manner as the front battery wiring module 10A, and the battery module 1 is completed.

### Operations and Effects of First Embodiment

According to the first embodiment, the following operations and effects are obtained.

The battery wiring module 10 according to the first embodiment is attached to the battery cell stack 20L including the plurality of battery cells 20 stacked and including the electrode leads 21, to electrically connect the plurality of battery cells 20 with each other. The battery wiring module 10 according to the first embodiment includes: the busbars 30 having a plate shape; the FPC 50 including the board-side connection portions 54; and the protector 70 holding the busbars 30 and the FPC 50. The busbars 30 include the main bodies 31 connected to the electrode leads 21, and the busbar-side connection portions 32 connected to the board-side connection portions 54. In the protector 70, a thickness direction of the main bodies 31 of the busbars 30 is the left-right direction, and a thickness direction of the FPC 50 is the front-rear direction. That is, in the protector 70, the main bodies 31 of the busbars 30, and the FPC 50 are arranged perpendicularly to each other.

According to the above configuration, in the protector 70, the main bodies 31 of the busbars 30 and the FPC 50 are arranged perpendicularly to each other. Therefore, it is possible to directly join the main bodies 31 of the busbars 30 to the electrode leads 21 without bending each of two adjacent ones of the electrode leads 21 toward the main body 31 of the busbar 30, so that the two adjacent ones lie on top of each other. Thus, the configuration of the battery wiring module 10 can be simplified. In addition, since a space in the protector 70 where the busbars 30 are installed is reduced, a space where the shapes for positioning the busbars 30 are installed is easily secured, and the space of the battery wiring module 10 can be reduced.

In the first embodiment, among the busbars 30, the intermediate busbars 30M disposed between the negative-electrode lead 21N and the positive-electrode lead 21P adjacent to each other are made of a clad material in which copper and aluminum are integrated.

In a case where copper and aluminum are joined by laser welding, an intermetallic compound of copper and aluminum is generally generated at the joined portion, and the joining strength decreases. For this reason, when the material of the intermediate busbar 30M is limited to any one of copper or aluminum, the joining strength decreases at a joined portion between the intermediate busbar 30M and the electrode lead 21 that is any one of the negative-electrode lead 21N and the positive-electrode lead 21P adjacent to each other, which is not preferable. However, according to the above configuration, since the intermediate busbar 30M includes joined metals having high connection strength for the negative-electrode lead 21N and the positive-electrode lead 21P, that is, copper and aluminum, it is possible to improve the joining strength between the intermediate busbar 30M and each of the negative-electrode lead 21N and the positive-electrode lead 21P adjacent to each other.

In the first embodiment, the FPC 50 includes the connection holes 53 through which the busbar-side connection portions 32 are inserted, and the board-side connection portions 54 are provided at the hole edge portions of the connection holes 53.

According to the above configuration, the busbar-side connection portions 32 and the board-side connection portions 54 can be connected in a state where the busbar-side connection portions 32 are inserted in the connection holes 53.

In the first embodiment, the protector 70 includes the positioning holes 74 that receive the distal ends of the busbar-side connection portions 32 inserted in the connection holes 53.

According to the above configuration, a space in the protector 70 where the busbars 30 are installed also serves as a positioning space, and the busbars 30 can be positioned with respect to the protector 70 without newly providing members for the busbars 30. Therefore, the space of the configuration of the battery wiring module 10 can be reduced.

In the first embodiment, the board-side connection portion 54 is connected to one side surface of the busbar-side connection portion 32 by soldering.

According to the above configuration, the work efficiency with which the board-side connection portions 54 are soldered to the busbar-side connection portions 32 is improved.

In the first embodiment, a circuit board is the FPC 50.

According to the above configuration, since the flexible printed circuit board is light and flexible, it is easy to assemble the battery wiring module 10.

### Second Embodiment

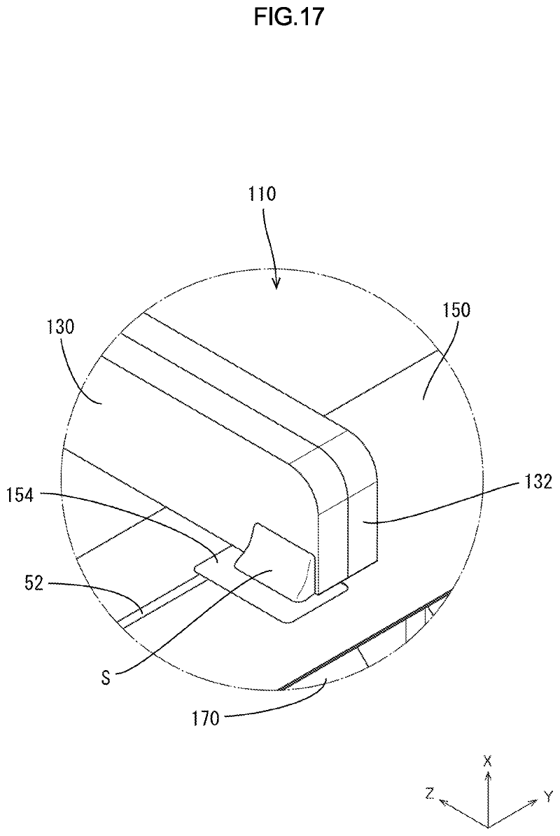

A second embodiment of the present disclosure will be described with reference to FIG. 17. In the following description, description of the same members, operations, and effects as those of the first embodiment will be omitted. Note that for a plurality of the same members, only some of the members may be denoted by a reference sign, and the reference sign of the other members may be omitted.

A battery wiring module 110 of the second embodiment includes busbars 130 having a plate shape, an FPC 150, and a protector 170 that holds the busbars 130 and the FPC 150.

As illustrated in FIG. 17, the FPC 150 is not provided with the connection holes 53 in the first embodiment. Board-side connection portions 154 of the FPC 150 have a rectangular shape. The protector 170 may or may not be provided with the positioning holes 74 in the first embodiment. Busbar-side connection portions 132 of the busbars 130 are formed such that the rearward protruding dimension is smaller than that of the busbar-side connection portions 32 of the busbars 30 of the first embodiment. Thus, in a state where the busbars 130 and the FPC 150 are held by the protector 170, rear end surfaces of the busbar-side connection portions 132 are disposed in contact with the board-side connection portions 154. The busbar-side connection portions 132 and the board-side connection portions 154 are electrically connected with solder S.

### Operations and Effects of Second Embodiment

According to the second embodiment, the following operations and effects are obtained.

The busbar-side connection portions 132 are surface-mounted on the board-side connection portions 154.

According to the above configuration, the busbar-side connection portions 132 and the board-side connection portions 154 can be connected by reflow without forming, thorough the FPC 150, holes corresponding to the connection holes 53 of the first embodiment. Thus, for example, in a case where the busbar-side connection portions 132 and the board-side connection portions 154 are connected with each other with the solder S, the solder S does not flow down through holes.

### Third Embodiment

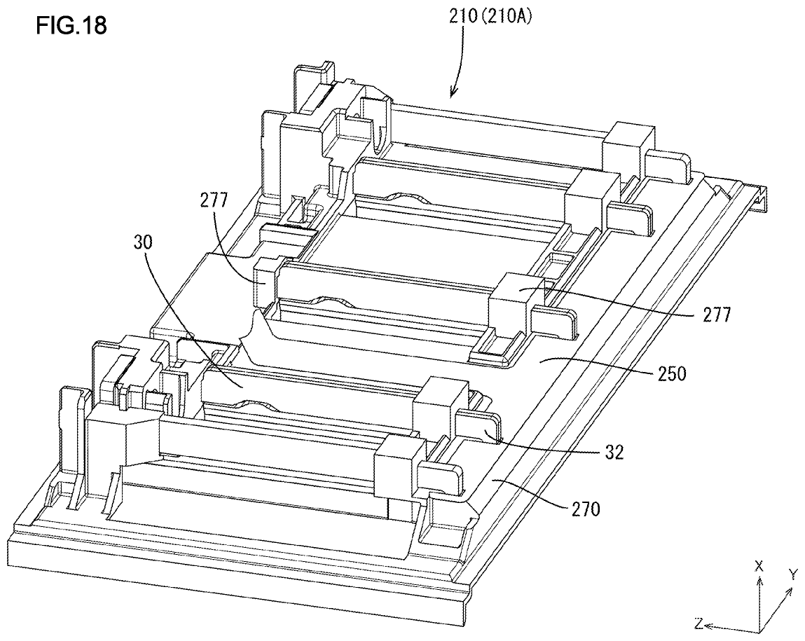

A third embodiment of the present disclosure will be described with reference to FIGS. 18 to 21. In the following description, description of the same members, operations, and effects as those of the first embodiment will be omitted. Note that for a plurality of the same members, only some of the members may be denoted by a reference sign, and the reference sign of the other members may be omitted.

Battery wiring modules 210 of the third embodiment include busbars 30 having a plate shape, an FPC 250, and a protector 270 that holds the busbars 30 and the FPC 250. Among the battery wiring modules 210, FIG. 18 illustrates a front battery wiring module 210A. In the present embodiment, the protector 270 and the busbars 30 are integrally molded by insert molding. The busbars 30 are held on the protector 270 by fixing portions 277. The distal ends of busbar-side connection portions 32 are integral with the protector 270.

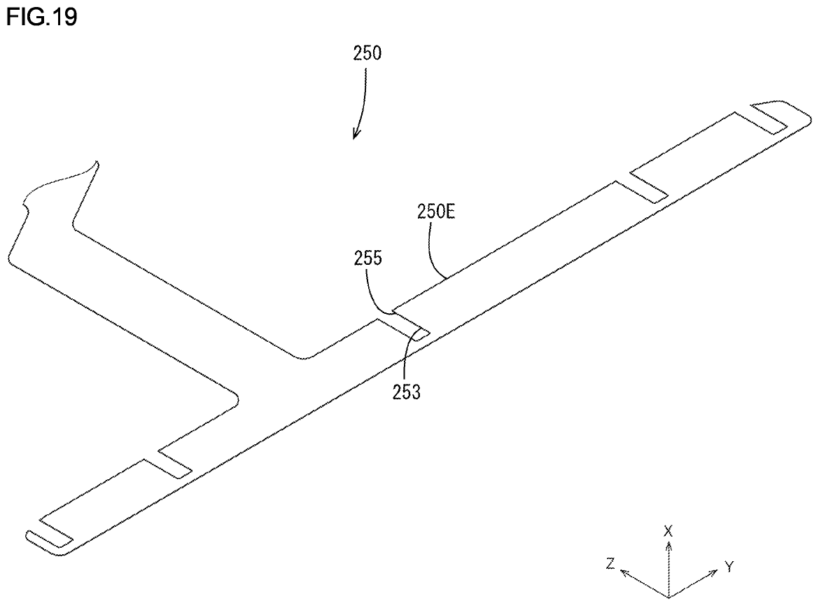

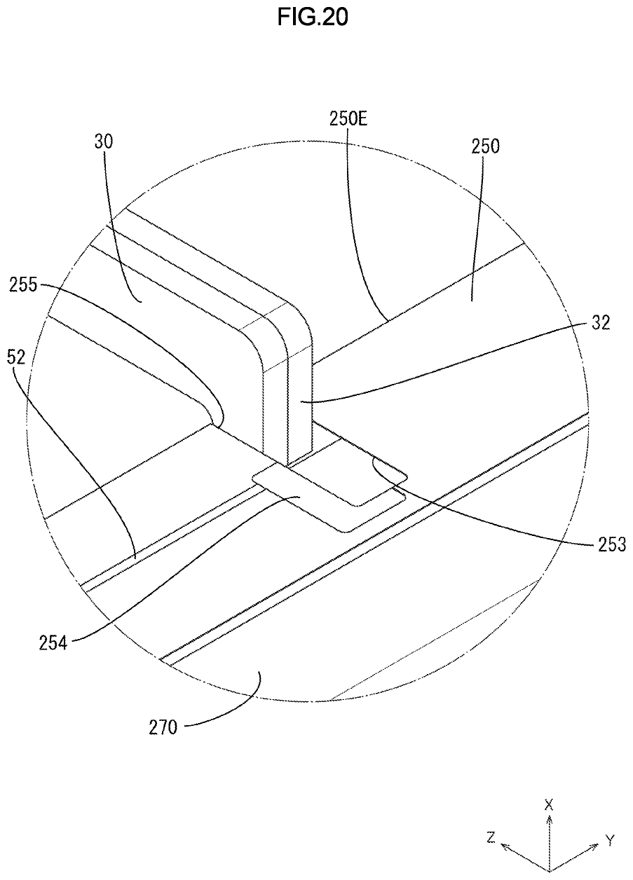

As illustrated in FIG. 19, the FPC 250 is provided with entry slits 255 continuous with connection holes 253. A slit edge portion of the entry slit 255 is continuous with an outer edge portion 250E of the FPC 250 and a hole edge portion of the connection hole 253. That is, the entry slit 255 does not have the outer edge portion 250E of the FPC 250, and opens upward at the position of the outer edge portion 250E of the FPC 250. The left-right-direction width of an opening of the entry slit 255 is the same as the left-right-direction width of the connection hole 253, and the hole edge portion of the connection hole 253 is linearly continuous, without unevenness, with the outer edge portion 250E via the slit edge portion of the entry slit 255. Since the left-right-direction width of the connection holes 253 is set larger than the left-right-direction width of the busbars 30, as illustrated in FIG. 20, the busbar-side connection portions 32 can be assembled with the connection holes 253 by sliding the FPC 250 upward while making the busbar-side connection portions 32 held by the protector 270 enter the entry slits 255.

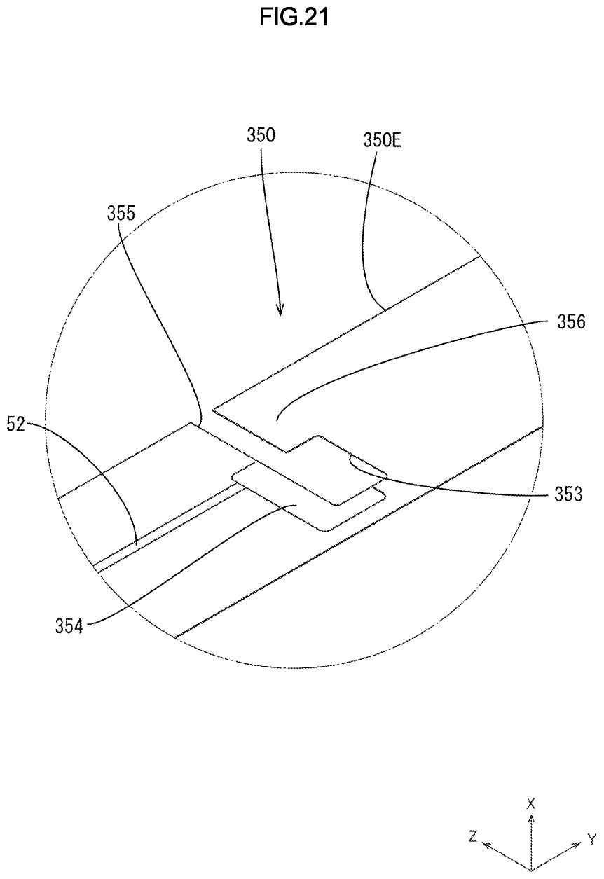

Alternatively, the battery wiring module 210 may include an FPC 350 illustrated in FIG. 21 instead of the FPC 250. The FPC 350 is provided with entry slits 355 continuous with connection holes 353. Similarly to the entry slits 255 described above, the entry slits 355 open upward at the position of an outer edge portion 350E of the FPC 350. Unlike the FPC 250, in the FPC 350, the left-right-direction width of openings of the entry slits 355 is formed narrower than the left-right-direction width of the connection holes 353. The left-right-direction width of the connection holes 353 is set larger than the left-right-direction width of the busbars 30, and the left-right-direction width of the entry slits 355 is set smaller than the left-right-direction width of the busbars 30. An engaging piece 356 is provided to the left of the entry slit 355, and protrudes rightward from a right hole edge portion of the connection hole 353.

### Assembly of Battery Wiring Module

Hereinafter, an example of an assembly procedure of the battery wiring module 210 to which insert molding is applied will be described.

The busbars 30 are preliminarily arranged in a mold (not illustrated) for molding the protector 270, and the mold is filled with insulating resin that has been thermally dissolved. Thereafter, the insulating resin and the busbars 30 are cooled in the mold, and taken out from the mold to form the protector 270 in which the busbars 30 are insert-molded.

As illustrated in FIG. 20, the FPC 250 is slid upward while the busbar-side connection portions 32 of the busbars 30 integral with the protector 270 are made to enter the entry slits 255 of the FPC 250, so that the busbar-side connection portions 32 are assembled with the connection holes 253. In a state where the busbar-side connection portions 32 are assembled with the connection holes 253, the FPC 250 is fixed to the protector 270, and the busbar-side connection portions 32 and board-side connection portions 254 are electrically connected by soldering. Thus, the battery wiring module 210 is completed.

In a case where the FPC 350 is used instead of the FPC 250, the engaging pieces 356 are bent to forcibly widen leftward the entry slits 355, to slide the FPC 350 upward while making the busbar-side connection portions 32 enter the entry slits 355, so that the busbar-side connection portions 32 are assembled with the connection holes 353. Thereafter, when the engaging pieces 356 are returned to the natural state, the busbar-side connection portions 32 inserted in the connection holes 353 are temporarily in a state of engaging with the engaging pieces 356, and the busbar-side connection portions 32 are less likely to detach from the connection holes 353. Therefore, it is easy to fix the FPC 350 to the protector 270, and to solder the busbar-side connection portions 32 to board-side connection portions 354.

### Operations and Effects of Third Embodiment

According to the third embodiment, the following operations and effects are obtained.

The hole edge portions of the connection holes 253 are formed in a recess shape, such that the hole edge portions are continuous with the outer edge portion 250E of the FPC 250 via the entry slits 255.

According to the above configuration, the busbar-side connection portions 32 can be assembled with the connection holes 253 after the busbars 30 are held by the protector 270. Therefore, in a manufacturing process of the battery wiring module 210, it is also possible to apply insert molding in which the protector 270 and the busbars 30 are integrally molded. Note that the above effects can also be obtained by using the FPC 350 instead of the FPC 250.

### Other Embodiments

(1) In the above embodiments, the electrode leads 21 of the battery cell stack 20L to which the battery wiring module 10, 110, or 210 is attached protrude forward and rearward; however, the electrode leads do not necessarily have such a configuration. The electrode leads of the battery cell stack to which the battery wiring module is attached may protrude in only one of front-rear directions.

(2) In the above embodiments, the negative electrode and the positive electrode of the battery module 1 are provided for the front battery wiring module 10, 110, or 210; however, the negative electrode and the positive electrode of the battery module do not necessarily have such a configuration. For example, the negative electrode of the battery module may be provided for the front battery wiring module, and the positive electrode of the battery module may be provided for the rear battery wiring module.

(3) In the above embodiments, the intermediate busbars 30M are made of a clad material in which two kinds of metals are integrated; however, the intermediate busbars do not necessarily have such a configuration. The intermediate busbars may be made of one kind of metal, or may be made of a clad material in which three or more kinds of metals are integrated.

(4) In the above embodiments, the flexible printed circuit board (the FPC 50, 150, 250, or 350) is used as a circuit board, but a printed circuit board (PCB), a flexible flat cable, a rigid flexible circuit board, or the like may be used. In a case where the circuit board, like the FPC 350 of the third embodiment, is bent and deformed at a time of assembling the battery wiring module, it is preferable to adopt a circuit board having flexibility.

(5) In the third embodiment, the FPC 250 or 350 provided with the entry slits 255 or 355 is assembled with the busbars 30 integrated with the protector 270 by insert molding; however, the busbars are not necessarily integrated with the protector by insert molding. The busbars and the protector may be provided separately, and after the busbars and the protector are assembled with each other, the FPC provided with the entry slits may be further assembled.

### REFERENCE SIGNS LIST

1: battery module
10, 110, 210: battery wiring module
10A, 210A: front battery wiring module
20: battery cell
20L: battery cell stack
21: electrode lead
21N: negative-electrode lead
21P: positive-electrode lead
22N, 22P: intermediate extension portion
23N: negative-electrode extension portion
23P: positive-electrode extension portion
30, 130: busbar
30M: intermediate busbar
30N: negative-electrode busbar
30P: positive-electrode busbar
31, 31M, 31N, 31P: main body
32, 132: busbar-side connection portion
33N: negative-electrode joining portion
33P: positive-electrode joining portion
34: coupling portion
35M: upper end portion
36N, 36P: terminal portion
37N, 37P: bent portion
38N, 38P: through hole
39: recess
50, 150, 250, 350: FPC
51A: base film
51B: coverlay film
52: conductive path
53, 253, 353: connection hole
54, 154, 254, 354: board-side connection portion
70, 170, 270: protector
71: electrode receiving portion
71M: intermediate electrode-receiving portion
71MR: right intermediate electrode-receiving portion
71ML: left intermediate electrode-receiving portion
71N: negative-electrode receiving portion
71P: positive-electrode receiving portion
72: contact portion
73: groove
74: positioning hole
75: holder
76: terminal block
250E, 350E: outer edge portion
255, 355: entry slit
277: fixing portion
356: engaging piece
S: solder

1. A battery wiring module attached to a battery cell stack including a plurality of battery cells stacked and including electrode leads, to electrically connect the plurality of battery cells with each other, the battery wiring module comprising:
busbars having a plate shape;
a circuit board including board-side connection portions; and
a protector holding the busbars and the circuit board, wherein
the busbars include main bodies connected to the electrode leads, and busbar-side connection portions connected to the board-side connection portions, and
in the protector, the main bodies of the busbars, and the circuit board are arranged perpendicularly to each other.

2. The battery wiring module according to claim 1, wherein among the busbars, the busbar disposed between the electrode leads adjacent to each other is made of a clad material in which two or more different kinds of metals are integrated.

3. The battery wiring module according to claim 1, wherein the busbar-side connection portions are surface-mounted on the board-side connection portions.

4. The battery wiring module according to claim 1, wherein
the circuit board includes connection holes through which the busbar-side connection portions are inserted, and
the connection holes have hole edge portions where the board-side connection portions are provided.

5. The battery wiring module according to claim 4, wherein the hole edge portions of the connection holes are formed in a recess shape, such that the hole edge portions are continuous with an outer edge portion of the circuit board.

6. The battery wiring module according to claim 4, wherein the protector includes positioning holes receiving distal ends of the busbar-side connection portions inserted in the connection holes.

7. The battery wiring module according to claim 1, wherein the board-side connection portions are connected to one side surface of the busbar-side connection portions by soldering.

8. The battery wiring module according to claim 1, wherein the circuit board is a flexible printed circuit board.
